(19) United States
(12) Patent Application Publication
(10) Pub. No.: US 2018/0106211 A1
(43) Pub. Date: Apr. 19, 2018

(54) METHOD FOR MANUFACTURING ENGINE

(71) Applicant: TOYOTA JIDOSHA KABUSHIKI KAISHA, Toyota-shi (JP)

(72) Inventor: Hiroki IGUMA, Sunto-gun (JP)

(73) Assignee: TOYOTA JIDOSHA KABUSHIKI KAISHA, Toyota-shi (JP)

(21) Appl. No.: 15/723,439

(22) Filed: Oct. 3, 2017

(30) Foreign Application Priority Data
Oct. 19, 2016 (JP) 2016-205313

(51) Int. Cl. F02F 1/24

(52) U.S. Cl. CPC F02F 1/24; F02F 2200/00

(57) ABSTRACT

A method for manufacturing an engine includes: preparing, as a preparing step, a cylinder head having a surface on which a ceiling surface of a combustion chamber is formed; forming, as a film formation step, a thermal insulation film on the ceiling surface; measuring, as a measurement step, a volume of the thermal insulation film; and selecting, as a selection step, from a plurality of ranks set in correspondence with compression heights of pistons, the rank of the piston to be combined with the ceiling surface, the selected rank corresponding to an amount of difference of the measured volume of the thermal insulation film from a design value of the volume of the thermal insulation film.

### INCORPORATION BY REFERENCE

The disclosure of Japanese Patent Application No. 2016-205313 filed on Oct. 19, 2016 including the specification, drawings and abstract is incorporated herein by reference in its entirety.

### BACKGROUND

### 1. Technical Field

The present disclosure relates to a method for manufacturing an engine and, more specifically, relates to a method for manufacturing an engine including a cylinder head.

### 2. Description of Related Art

A method for manufacturing a cylinder head of an engine is disclosed in Japanese Unexamined Patent Application Publication No. 2011-256730 (JP 2011-256730 A). The method includes casting a cylinder head element in which a recessed portion constituting a part of a combustion chamber is formed, cutting a mating surface of the cylinder head element with a cylinder block, measuring the distance in the height direction from a reference surface disposed at a top portion of the recessed portion to the mating surface, and adjusting the removal rate of the surface of the recessed portion based on the distance. Measuring the distance in the height direction enables acquisition of an error in the capacity of the combustion chamber with respect to a reference. Accordingly, the method that adjusts the removal rate of the surface of the recessed portion based on the distance in the height direction enables the capacity of the combustion chamber to fall within a defined range.

### SUMMARY

In order to improve capability of the engine, a thermal insulation film may be formed on a ceiling surface of the combustion chamber that is the surface of the recessed portion. When the thermal insulation film is formed on the ceiling surface, a capability to reduce heat generated in the combustion chamber radiating outwards through the ceiling surface (thermal insulation capability) can be increased. When the thermal insulation film is formed on the ceiling surface, the capacity of the combustion chamber is decreased by the volume of the thermal insulation film. Thus, forming the thermal insulation film on the ceiling surface leads to a study of adjusting the capacity of the combustion chamber in accordance with the volume. However, forming the thermal insulation film on the ceiling surface means forming the thermal insulation film after cutting of the ceiling surface is finished. Thus, cutting the ceiling surface is practically difficult after formation of the thermal insulation film.

Cutting the surface of the thermal insulation film is also possible instead of cutting the ceiling surface after formation of the thermal insulation film. The film thickness of the thermal insulation film is highly correlated with the thermal insulation capability. Thus, cutting the film surface is favorable if performed at a grinding level. However, when the film thickness is significantly decreased by adjusting the removal rate of the thermal insulation film based on the distance in the height direction as in the method, a desired thermal insulation capability may not be acquired.

The present disclosure provides a method for manufacturing an engine, the method enabling the capacity of a combustion chamber to fall within a defined range without overcutting a film surface when a thermal insulation film is formed on a ceiling surface of the combustion chamber formed on the surface of a cylinder head.

An aspect of the present disclosure relates to a method for manufacturing an engine. The method includes: preparing, as a preparing step, a cylinder head having a surface on which a ceiling surface of a combustion chamber is formed; forming, as a film formation step, a thermal insulation film on the ceiling surface; measuring, as a measurement step, a volume of the thermal insulation film; and selecting, as a selection step, from a plurality of ranks set in correspondence with compression heights of pistons, the rank of the piston to be combined with the ceiling surface, the selected rank corresponding to an amount of difference of the measured volume of the thermal insulation film from a design value of the volume of the thermal insulation film.

The method according to the aspect may further include recording, on the surface of the cylinder head, information related to the rank selected in the selection step.

In the method according to the aspect, in the selection step, the selected rank of the piston may be the rank having the compression height that minimizes an amount of difference of a capacity of the combustion chamber at a time of the piston being in a top dead center position from a design value of the capacity of the combustion chamber, the amount of difference of the capacity of the combustion chamber being generated by the amount of difference of the measured volume of the thermal insulation film from the design value of the volume of the thermal insulation film.

In the method according to the aspect, the thermal insulation film formed in the film formation step may be the thermal insulation film having a porous structure.

The aspect enables selection of the rank of the piston to be combined with the ceiling surface from the plurality of ranks set in correspondence with the compression heights of the pistons, the selected rank corresponding to the amount of difference of the measured volume of the thermal insulation film from the design value of the volume of the thermal insulation film. Accordingly, even if the measured volume of the thermal insulation film departs from the designed value, an influence by the difference of the measured volume is reduced by the thickness at the rank thus selected, so that the capacity of the combustion chamber can fall within the defined range. Accordingly, it is possible to avoid cutting of a film surface more than necessary and to put the capacity of the combustion chamber within the defined range.

The aspect enables recording of the information related to the selected rank on the surface of the cylinder head. Accordingly, the capacity of the combustion chamber can be caused to fall within the defined range when the engine is actually assembled. In addition, when the piston is replaced with a new one, a change in the capacity of the combustion chamber can be prevented.

The aspect enables selection of the rank that minimizes the amount of difference of the capacity of the combustion chamber at the time of the piston being in the top dead center position from the design value of the capacity of the combustion chamber, the amount of difference of the capacity of the combustion chamber being generated by the amount of difference of the measured volume of the thermal insulation film from the design value of the volume of the thermal insulation film. Accordingly, even if the measured volume of the thermal insulation film departs from the designed value, an influence by the difference of the measured volume is reduced by the thickness at the rank thus selected, so that the capacity of the combustion chamber can fall within the defined range. Accordingly, it is possible to avoid cutting of a film surface more than necessary and to put the capacity of the combustion chamber within the defined range.

The aspect enables manufacturing of an engine that can exhibit a high thermal insulation capability by a thermal insulation film having a porous structure.

### BRIEF DESCRIPTION OF THE DRAWINGS

Features, advantages, and technical and industrial significance of exemplary embodiments of the present disclosure will be described below with reference to the accompanying drawings, in which like numerals denote like elements, and wherein:

FIG. 1 is a flowchart illustrating a method for manufacturing an engine according to an embodiment of the present disclosure;

FIG. 2 is a diagram illustrating one example of a method for measuring the film thickness of a thermal insulation film in step S4 in FIG. 1;

FIG. 3 is a diagram illustrating an example in which the thermal insulation film is inclined with respect to a ceiling surface of a combustion chamber;

FIG. 4 is a diagram illustrating an example of two pistons having different specifications of compression height; and

FIG. 5 is a diagram schematically illustrating examples of engines having combinations of the pistons and ceiling surfaces of combustion chambers on which thermal insulation films having different film thicknesses are formed.

### DETAILED DESCRIPTION OF EMBODIMENTS

Hereinafter, an embodiment of the present disclosure will be described based on the drawings. Common elements in each drawing will be designated by the same reference signs and will be described once. An applicable embodiment of the present disclosure is not limited to the following embodiment.

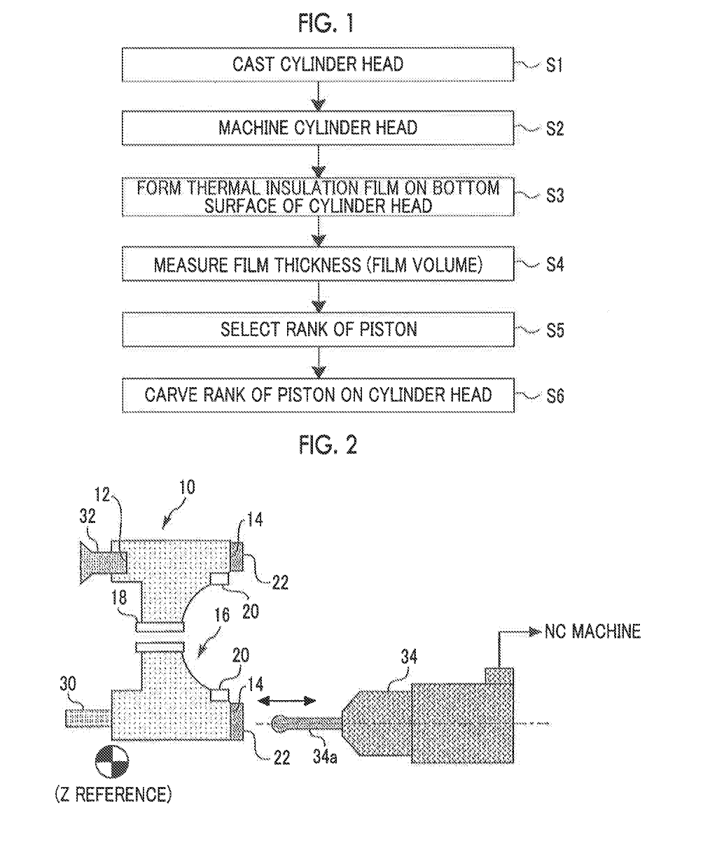

FIG. 1 is a flowchart illustrating a method for manufacturing an engine according to the embodiment of the present disclosure. As illustrated in FIG. 1, in the method according to the present embodiment, first, a cylinder head element of an engine is cast (step S1). The cylinder head element has a ceiling surface of a combustion chamber on the surface thereof. The combustion chamber is defined as a space that is enclosed, when a cylinder head manufactured by the method according to the present embodiment is incorporated into a cylinder block, with a bore surface of the cylinder block, a top surface of a piston accommodated in the bore surface, a lower surface of the cylinder head, and lower surfaces of umbrella portions of an intake valve and an exhaust valve disposed in the cylinder head.

The cylinder head element includes at least an intake port in which the intake valve is disposed, and an exhaust port in which the exhaust valve is disposed. In step S1, for example, a plurality of cores forming the intake port and the exhaust port is disposed inside a mold. Next, molten aluminum alloy is poured into the mold. After solidification of the molten aluminum alloy, the cylinder head element is taken out of the mold. Such a method for casting a cylinder head element is known as disclosed in, for example, Japanese Unexamined Patent Application Publication No. 2000-356165 (JP 2000-356165 A) and will not be further described.

After step S1, the cylinder head element is machined (step S2). In step S2, valve guides supporting stem portions of the intake valve and the exhaust valve and holes to which seat rings where the umbrella portions of the valves sit are attached are formed by drilling. In step S2, in addition, a hole into which a positioning pin used in step S4 described below is inserted, a hole where the cylinder head element is fastened to the cylinder block, an oil passage in which lubricating oil flows, and the like are formed by drilling. In step S2, furthermore, inner surfaces of the intake port and the exhaust port formed in step S1 are cut. After the processes, valve guides and seat rings are inserted into corresponding holes by press-fitting, shrink-fitting, or cold fitting.

After step S2, a thermal insulation film is formed on the ceiling surface of the combustion chamber (step S3). In step S3, for example, the thermal insulation film is formed as follows. First, nickel-chromium-based ceramic particles are thermally sprayed on the entire ceiling surface. Next, zirconia particles are thermally sprayed on the entire surface of the nickel-chromium-based film. Such two stages of thermal spraying can form a thermally sprayed film including a nickel-chromium-based intermediate layer and a zirconia surface layer as the thermal insulation film. The thermally sprayed film has a porous structure due to internal air bubbles formed in the process of thermal spraying. Therefore, the thermally sprayed film functions as the thermal insulation film having a lower thermal conductivity and a lower volumetric heat capacity than the cylinder head element. The type of thermal spraying is not particularly limited, and various types such as flame spraying, high velocity flame spraying, arc spraying, plasma spraying, and laser spraying are employed.

In step S3, instead of thermally spraying the nickel-chromium-based ceramic particles and zirconia particles, an appropriate combination of ceramic particles of silicon nitride, yttria, titanium oxide, or the like and composite ceramic particles of cermet, mullite, cordierite, steatite, or the like may be thermally sprayed. In addition, in step S3, an anodic oxide film may be formed on the ceiling surface. A coating film of heat insulation paint including hollow particles may be formed on the ceiling surface. An inorganic silica film having air bubbles formed by a foaming agent may be formed on the ceiling surface. Such films have a porous structure in the same manner as the thermally sprayed film and function as the thermal insulation film having a lower thermal conductivity and a lower volumetric heat capacity than the cylinder head element. In addition, in step S3, a coating film of heat insulation paint or an inorganic silica film may be formed on the ceiling surface. Although these films do not have a porous structure, they function as a thermal insulation film having a lower coefficient of thermal conductivity than the cylinder head material.

In step S3, the film thickness of the thermal insulation film formed on the ceiling surface is adjusted in a range of 50 μm to 200 μm in accordance with target thermophysical properties (thermal conductivity and volumetric heat capacity). Fine roughness due to the porous structure may be generated on the surface of the thermal insulation film. Thus, polishing is desirably performed at the time of adjustment of the film thickness of the thermal insulation film in order to smooth the film surface. Polishing for smoothing is desirably performed to a minimum extent since over-polishing leads to damage to the thermal insulation film due to the structure of the thermal insulation film.

After step S3, the film thickness of the thermal insulation film is measured (step S4). FIG. 2 is a diagram illustrating one example of a method for measuring the film thickness of the thermal insulation film. As illustrated in FIG. 2, a cylinder head element 10 has a hole 12. The hole 12 is formed in step S2. A positioning pin 32 for X and Y references included in a processing stage 30 is inserted into the hole 12. Accordingly, the cylinder head element 10 is fixed in a reference position (Z reference) in the processing stage 30.

In FIG. 2, a ceiling surface 14 of a combustion chamber included in the cylinder head element 10 is partially illustrated. In FIG. 2, in addition, one port (an intake port or an exhaust port) 16 included in the cylinder head element 10 is illustrated, and a seat ring 18 described in step S2 is inserted into an opening portion on the ceiling surface 14 side of the port 16. A valve guide 20 described in step S2 is inserted into a hole communicating with the port 16. A thermal insulation film 22 described in step S3 is formed on the ceiling surface 14.

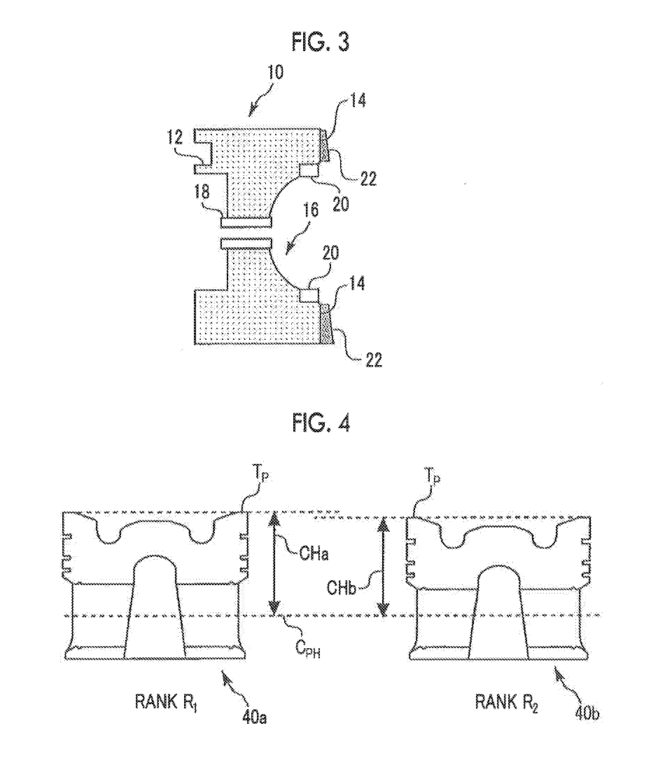

A coordinate measuring unit 34 mounted in a numerical control (NC) machine faces the thermal insulation film 22. The coordinates of the thermal insulation film 22 in the film thickness direction are measured by moving a gauge 34a of the coordinate measuring unit 34 to the vicinity of the thermal insulation film 22. The measured values of the coordinates are output to a controller of the NC machine and recorded. Measurement of the coordinates using the coordinate measuring unit 34 is desirably performed in a plurality of places on the thermal insulation film 22. The reason is because the thermal insulation film 22 may be inclined with respect to the ceiling surface 14 as illustrated in FIG. 3. For example, if the average values of the coordinates after measuring the coordinates in a plurality of places are acquired, the film thickness of the thermal insulation film 22 can be more accurately acquired.

In step S4, instead of using the coordinate measuring unit 34 illustrated in FIG. 2 to measure the film thickness of the thermal insulation film 22, a known device such as a laser displacement gauge, step height measurement using line laser light, and an eddy current film thickness gauge may be used to measure the film thickness of the thermal insulation film 22.

Description of the method for manufacturing continues with reference to FIG. 1, again. After step S4, a rank of a piston to be combined with the ceiling surface is selected (step S5). In step S5, for example, s volume of the thermal insulation film is calculated from a product of the film thickness of the thermal insulation film measured in step S4 and an area of the formed film. When the thermal insulation film has a porous structure, the volume of the thermal insulation film is calculated as the volume of the entire film including the internal pores. The area of the formed film is basically not measured since the region in which the thermal insulation film is formed is known in step S3. For example, when the thermal insulation film is formed on the entire ceiling surface, the surface area of the ceiling surface may be used as the area of the formed film. If the volume of the thermal insulation film is to be calculated with accuracy, the area of the formed film may be calculated by measuring the coordinates of the thermal insulation film using the coordinate measuring unit 34 illustrated in FIG. 2 or the like.

The rank of the piston selected in step S5 is a rank that corresponds to a compression height. FIG. 4 is a diagram illustrating an example of two pistons having different specifications of compression height. A compression height CH means the distance from a center C_{PH} of a hole into which a piston pin is inserted to a top end T_{P} of a top land of the piston. When the compression heights CH of a piston 40a and a piston 40b illustrated in FIG. 4 are compared with each other, the compression height CH of the piston 40b (compression height CHb) is lower than the compression height CH of the piston 40a (compression height CHa). The piston 40a is classified into, for example, a rank R₁, and the piston 40b is classified into, for example, a rank R₂.

While two ranks R₁, R₂ as the rank of the piston are illustrated in FIG. 4, the number of ranks of the piston, targeted for the selection in step S5, can obviously be set to three or more. The pistons having different compression heights CH can be prepared by, for example, cutting the top surface of the piston of a reference rank and changing the width from a top ring groove to the top end T_{P} of the top land (top land width). Changing the top land width can minimize variations in the attitude of the piston accompanied by a change in the compression height CH and does not affect oil consumption or piston slap. In this case, the surface of a recessed portion such as a cavity is desirably cut such that the capacity of the recessed portion is not changed before and after a change in the top land width. When a valve recess is formed on the top surface of the piston, the depth of the valve recess is desirably adjusted by cutting the surface of the valve recess in order to prevent valve stamping.

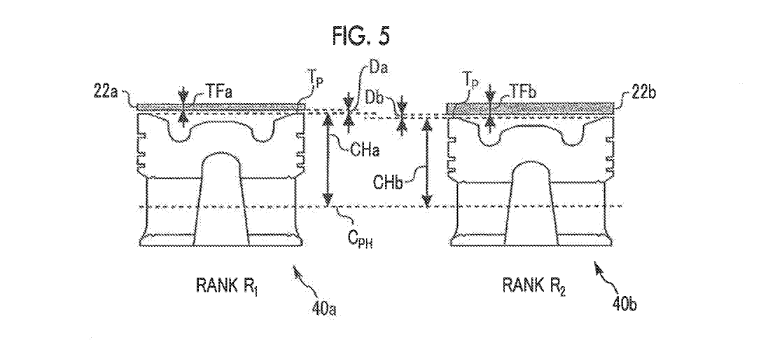

In step S5, for example, a piston of a rank that can minimize the amount of difference of the capacity of the combustion chamber at the time of the piston being in a top dead center position from a design value of the capacity of the combustion chamber is selected, the amount of difference of the capacity of the combustion chamber being generated by the amount of difference of the measured volume of the thermal insulation film calculated in step S5 from a design value of the volume of the thermal insulation film. The design value of the volume of the thermal insulation film is set in advance as the volume of the thermal insulation film formed on the ceiling surface by considering the film thickness adjusted in step S3 and the area of the formed film. FIG. 5 is a diagram schematically illustrating examples of engines having combinations of the pistons and ceiling surfaces of combustion chambers on which thermal insulation films having different film thicknesses are formed. In FIG. 5, the pistons at the top dead center and the thermal insulation films are illustrated, and cylinders accommodating the pistons and the ceiling surfaces on which the thermal insulation films are formed are not illustrated.

When film thicknesses TF of a thermal insulation film 22a and a thermal insulation film 22b illustrated in FIG. 5 are compared with each other, the thermal insulation film 22b (film thickness TFb) is thicker than the thermal insulation film 22a (film thickness TFa). Therefore, for example, the thermal insulation film 22a is combined with the piston 40a of the rank R₁ of which the compression height CH is relatively high. For example, the thermal insulation film 22b is combined with the piston 40b of the rank R₂ of which the compression height CH is relatively low. By doing so, a distance Da from the top end T_{P} to the thermal insulation film or a distance Db from the top end T_{P} to the thermal insulation film falls within a predetermined range. That is, the capacity of the combustion chamber falls within a predetermined range in any of the engines illustrated in FIG. 5.

Description of the method for manufacturing continues with reference to FIG. 1, again. After step S5, the rank of the piston selected in step S5 is marked on the cylinder head (step S6). The marking as information indicating the rank of the piston to be combined with the ceiling surface is recorded on the surface of the cylinder head that can be visually seen from the outside. This information is recorded by stamping of a mark or by engraving of a mark by laser machining, for example. A QR code (registered trademark) may be used instead of a sign. An identification by the position or number of notches may be used instead of a sign. Recording such information allows selection of a piston of an optimal rank combined with the ceiling surface not only when an engine is assembled but also when the engine is disassembled to replace the piston with a new one.

The method according to the present embodiment described heretofore can determine an optimal rank of a piston to be combined with the ceiling surface based on the volume of the thermal insulation film formed on the ceiling surface. Accordingly, the capacity of the combustion chamber when an engine is assembled can be caused to fall within a predetermined range. In addition, the method according to the present embodiment can record the optimal rank of the piston on the cylinder head. Accordingly, the capacity of the combustion chamber can be prevented from departing from the predetermined range not only when an engine is assembled but also when the piston is replaced with a new one.

In the embodiment, steps S1, S2 in FIG. 1 correspond to “preparing” of an aspect, and Step S3 corresponds to “forming” of the aspect. Step S4 corresponds to “measuring” of the aspect, and step S5 corresponds to “selecting” of the aspect. In the embodiment, step S6 in FIG. 1 corresponds to “recording” of the aspect.

The embodiment is described by assuming that a piston of a rank that minimizes the amount of difference of the capacity of the combustion chamber at the time of the piston being in the top dead center position from the design value of the capacity of the combustion chamber is selected, the amount of difference of the capacity of the combustion chamber being generated by the amount of difference of the measured volume of the thermal insulation film from the design value of the volume of the thermal insulation film. However, a piston of a different rank from the rank minimizing the amount of difference of the capacity of the combustion chamber can be selected instead of the piston of the rank minimizing the amount of difference of the capacity of the combustion chamber, if the piston belongs to a rank that can cause the capacity of the combustion chamber to fall within a predetermined range as a result when the piston is combined with the ceiling surface (for example, a piston of a rank that has the second smallest amount of difference). That is, if a piston belongs to a rank corresponding to the amount of difference of the capacity of the combustion chamber, the piston can be selected instead of the piston of the rank minimizing the amount of difference of the capacity of the combustion chamber.

What is claimed is:

1. A method for manufacturing an engine, the method comprising:
preparing, as a preparing step, a cylinder head having a surface on which a ceiling surface of a combustion chamber is formed;
forming, as a film formation step, a thermal insulation film on the ceiling surface;
measuring, as a measurement step, a volume of the thermal insulation film; and
selecting, as a selection step, from a plurality of ranks set in correspondence with compression heights of pistons, the rank of the piston to be combined with the ceiling surface, the selected rank corresponding to an amount of difference of the measured volume of the thermal insulation film from a design value of the volume of the thermal insulation film.

2. The method according to claim 1, further comprising:
recording, on the surface of the cylinder head, information related to the rank selected in the selection step.

3. The method according to claim 1, wherein in the selection step, the selected rank of the piston is the rank having the compression height that minimizes an amount of difference of a capacity of the combustion chamber at a time of the piston being in a top dead center position from a design value of the capacity of the combustion chamber, the amount of difference of the capacity of the combustion chamber being caused by the amount of difference of the measured volume of the thermal insulation film from the design value of the volume of the thermal insulation film.

4. The method according to claim 1, wherein the thermal insulation film formed in the film formation step is a thermal insulation film having a porous structure.
